(19) United States
(12) Patent Application Publication
(10) Pub. No.: US 2005/0223142 A1
(43) Pub. Date: Oct. 6, 2005

(54) Memory mouse

(75) Inventor: Yuan-Biing Sung, Sansia Township (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 10/889,108

(22) Filed: Jul. 13, 2004

(30) Foreign Application Priority Data
Mar. 31, 2004 (TW) 093204921

(51) Int. Cl. G06F 13/12

(52) U.S. Cl. 710/62

(57) ABSTRACT

A memory mouse includes a mouse, which has an input device for data input and a cable with a connector connectable to one connector port of a computer, a memory device mounted inside the mouse for storing data, and a microprocessor mounted inside the mouse and electrically connected to the input device and the cable of the mouse as well as the memory device. The microprocessor controls switching between the communication protocol of the input device and the communication protocol of the memory device, enabling the cable with the connector to transmit signal from the input device or the memory device.

### BACKGROUND OF THE INVENTION

1. Field of the Invention

The present invention relates to a mouse for use with a computer for data input and more particularly, to a memory mouse.

2. Description of Related Art

A regular computer system, either desktop computer or notebook computer, is generally equipped with a mouse for data input. The mouse has a connector connected to one connection port, for example, a USB (Universal Serial Bus) port on the computer.

Further, a computer system has storage devices for storing data. From early fixed hard disk to later disk rack and current memory stick (or the so-called thumb disk), a data storage device has a connector connectable to a connection port on a computer. The connector and the matching connection port can be, for example, a USB (Universal Serial Bus) design.

Conventionally, a mouse and a memory stick are pertained to two different categories, i.e., the former is for data input, and the later is for storing data. These two items are separately prepared and occupy two connection ports at a computer.

### SUMMARY OF THE INVENTION

The present invention has been accomplished under the circumstances in view. It is therefore the main object of the present invention to provide a memory mouse, which incorporates a data input device and a data memory device into an integrated device for easy carrying and convenient use.

To achieve this and other objects of the present invention, the memory mouse comprises a mouse, a memory device, and a microprocessor. The mouse comprises a housing defining therein an internal chamber, an input device for data input, and a cable extended from the front side thereof and terminating in a connector, which is connectable to one connection port of an electronic apparatus. The memory device and the microprocessor are mounted inside the internal chamber of the mouse. The input device and cable of the mouse and the memory device are respectively electrically connected to the microprocessor. The microprocessor controls switching to the communication protocol of the input device, to let the cable with the connector transmit signal from the input device. The microprocessor also controls switching to the communication protocol of the memory device, to let the cable and the connector transmit signal from the memory device.

As indicated above, the mouse has the memory device and the microprocessor directly mounted therein. By means of the microprocessor, the operation mode of the memory mouse is directly switched to the input device of the mouse or the communication protocol of the memory device, enabling the connector to transmit signal from the input device or the memory device, i.e., the invention has the input function of a mouse be incorporated with a memory device into an integrated device for convenient carrying and use. Further, when incorporated the input device of a mouse with a memory device into an integrated device, one single connector, for example, one USB connector is sufficient for signal transmission to one USB port of an electronic apparatus.

### BRIEF DESCRIPTION OF THE DRAWINGS

FIG. 1 is a perspective cutaway of a memory mouse according to the present invention.

FIG. 2 is a system block diagram of the present invention.

### DETAILED DESCRIPTION OF THE PREFERRED EMBODIMENT

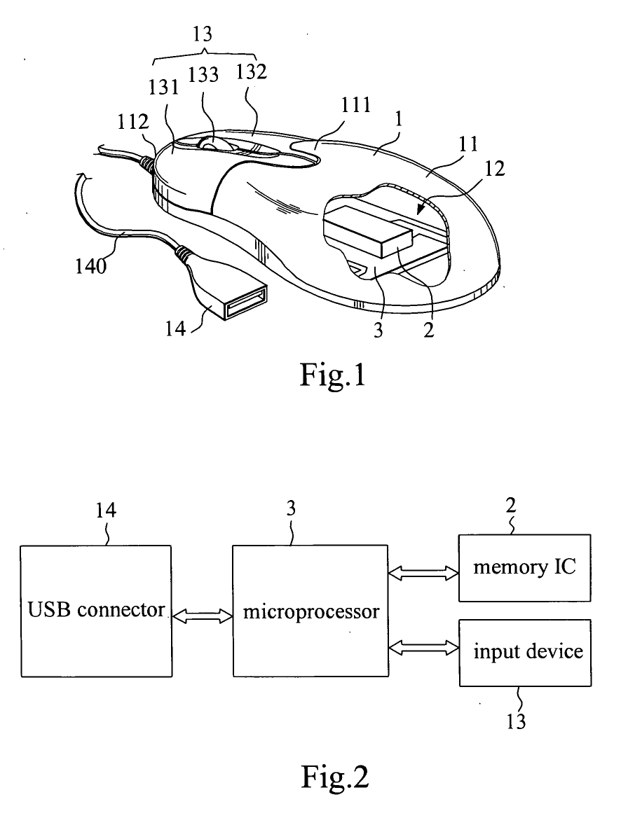

Referring to FIG. 1, a memory mouse in accordance with the present invention is shown comprised of a mouse 1, a memory device 2, and a microprocessor 3.

The mouse 1 comprises a housing 11 defining an internal chamber 12, an input device 13 installed on the top wall 111 of the housing 11, a cable 140 extended from the front side 112 of the housing 11 of the mouse 1, and a connector 14 provided at the distal end of the cable 140. The input device 13 is comprised of a left button 131, a right button 132, and roller 133. The connector 14 according to the present preferred embodiment is a USB (Universal Serial Bus) connector connectable to a USB port on a computer.

Further, the memory device 2 and the microprocessor 3 are mounted inside the internal chamber 12 of the housing 11 of the mouse 1. According to the present preferred embodiment, the memory device 2 is a memory IC. Any of a variety of known memory devices may be used as a substitute.

Referring to FIG. 2 and FIG. 1 again, the input device 13 of the mouse 1, the connector 14 of the mouse 1, and the memory device 2 are respectively electrically connected to the microprocessor 3. When wishing to use the input device 13 for data input, the microprocessor 3 is used to control switching of the function of the mouse 1 to the communication protocol of the input device 13, enabling the USB connector 14 of the mouse 1 to transmit signal from the left button 131, the right button 132, or the roller 133. When wishing to use the memory device 2 for storing data, the microprocessor 3 is used to control switching of the function of the mouse 1 to the communication protocol of the memory device 2, enabling the USB connector 14 of the mouse 1 to transmit signal.

As indicated above, the mouse 1 has the memory device 2 and the microprocessor 3 directly mounted therein. By means of the microprocessor 3, the operation mode of the memory mouse is directly switched to the input device 13 of the mouse 1 or the communication protocol of the memory device 2, enabling the connector 14 to transmit signal from the input device 13 or the memory device 2, i.e., the aforesaid arrangement has the input function of the mouse 1 be incorporated with the data storage function of the memory device 2 for convenient carrying and use. Further, when incorporated the input device 13 and the memory device 2 into an integrated device, one single connector, namely, the aforesaid USB connector 14 is sufficient for signal transmission to an external device, for example, a USB port on a computer.

Although the present invention has been explained in relation to its preferred embodiment, it is to be understood that many other possible modifications and variations can be made without departing from the spirit and scope of the invention as hereinafter claimed.

1. A memory mouse comprising:
a mouse, said mouse comprising an internal chamber, an input device for data input, and a cable extended from a front side thereof and terminating in a connector connectable to a connection port of an electronic apparatus;
a memory device mounted inside the internal chamber of said mouse for storing data; and
a microprocessor mounted inside the internal chamber of said mouse and electrically connected to said input device and said cable and said memory device, said microprocessor controlling switching to the communication protocol of said input device to let said cable and said connector transmit signal from said input device, and said microprocessor controlling switching to the communication protocol of said memory device to let said cable and said connector transmit signal from said memory device.

2. The memory mouse as claimed in claim 1, wherein said memory device is a memory IC.

3. The memory mouse as claimed in claim 1, wherein the input device of said mouse comprises a left button, a right button, and a roller.
